(19) United States
(12) Patent Application Publication
(10) Pub. No.: US 2018/0096792 A1
(43) Pub. Date: Apr. 5, 2018

(54) Magnetic Capacitor

(71) Applicant: Alexander Mikhailovich Shukh, San Jose, CA (US)

(72) Inventor: Alexander Mikhailovich Shukh, San Jose, CA (US)

(21) Appl. No.: 15/284,542

(22) Filed: Oct. 4, 2016

(51) Int. Cl. H01G 4/30; H01G 4/12; H01G 4/005

(52) U.S. Cl. CPC H01G 4/30; H01G 4/005; H01G 4/1227

(57) ABSTRACT

An apparatus for storing an electrical energy comprising: a first conductive electrode, a second conductive electrode, an isolative layer disposed between the first and second conductive electrodes, a first magnetic layer disposed between the isolative layer and the first conductive electrode, and a second magnetic layer disposed between the isolative layer and the second conductive electrode, wherein the isolative layer comprising at least: a first sublayer having a band gap equal or more than 5 eV, and a second sublayer having the band gap less than 5 eV.

### CROSS-REFERENCE TO RELATED APPLICATIONS

Not applicable.

### FEDERALLY SPONSORED RESEARCH

Not applicable.

### SEQUENCE LISTING OF PROGRAM

Not applicable.

### BACKGROUND

Energy storage devices such as capacitors and batteries play a significant role in our life. The capacitors are widely used in electronic circuits. The batteries found a broad application in numerous portable devices to store an electrical energy. The energy storage devices substantially influence performance and the working time of electrical devices.

However, traditional energy storage parts have some problems. For example, the capacitors have a low capacitance, a low energy density and suffer from a current leakage decreasing overall performance. The batteries have the memory problem of being partially charged/discharged and decreasing overall performance.

A Giant Magnetoresistance Effect (GMR) is a quantum mechanical effect observed in multilayer structures with alternating thin magnetic and nonmagnetic layers. The GMR effect shows a significant change in electrical resistance between two ferromagnetic layers separated from each other by a thin layer of nonmagnetic conductive material. The resistance of a multilayer structure can exhibit several times increase when a mutual orientation of magnetization directions in the adjacent ferromagnetic layers is changing from parallel to anti-parallel. Even higher resistance difference between the parallel and anti-parallel orientations of magnetization directions can be observed when two magnetic layers are separated by a thin layer on dielectric or semiconductor material. The difference in the resistance between two states of the magnetization can reach a thousand percents. The mutual orientation of the magnetization directions in the magnetic layers can be controlled by an external magnetic field or by a spin-polarized current running through the multilayer structure in a direction perpendicular to a plane of the layers. Hence, the GMR effect can be used to reduce a current leakage in the energy storage devices such as capacitors.

For the foregoing reasons, there is a need to develop a capacitor employing the GMR effect to store the electrical energy.

### SUMMARY

According to one embodiment of the present application, an apparatus for storing an electrical energy comprises a first conductive electrode, a second conductive electrode, an isolative layer disposed between the first and second conductive electrodes, a first magnetic layer disposed between the isolative layer and the first conductive electrode, and a second magnetic layer disposed between the isolative layer and the second conductive electrode, wherein the isolative layer comprises at least a first sublayer having a band gap equal or more than 5 eV, and a second sublayer having the band gap less than 5 eV.

According to another embodiment of the present application, an apparatus for storing an electrical energy comprises a first conductive electrode, a second conductive electrode, an isolative layer disposed between the first and second conductive electrodes and comprising a multilayer structure, a first magnetic layer disposed between the isolative layer and the first conductive electrode, and a second magnetic layer disposed between the isolative layer and the second conductive electrode, wherein the isolative layer comprises a first sublayer disposed adjacent to the first magnetic layer and comprising a material having a band gap equal or more than 5 eV, a second sublayer comprising a material having the band gap less than 5 eV, and a third sublayer disposed adjacent to the second magnetic layer and comprising a material having the band gap equal or more than 5 eV.

### BRIEF DESCRIPTION OF THE DRAWINGS

These and other features, aspects, and advantages of the present application will become better understood with regard to the following description, appended claims, and accompanying drawings where:

FIGS. 1A and 1B are schematic diagrams illustrating a cross-sectional view of a magnetic capacitor with an in-plane magnetization direction (parallel and anti-parallel, respectively) according to a first embodiment of the present application.

FIGS. 2A and 2B are schematic diagrams illustrating a cross-sectional view of a magnetic capacitor with a perpendicular magnetization direction (parallel and anti-parallel, respectively) according to a second embodiment of the present application.

FIG. 3 shows a magnetic capacitor when the capacitor according to the present application is charging.

FIG. 4 is a dependence of a relative permittivity on a band gap for dielectric and semiconductor materials.

FIG. 5 is a dependence of a breakdown (dielectric) strength on a band gap for dielectric and semiconductor materials.

FIG. 6 is a schematic diagram illustrating a cross-sectional view of a magnetic capacitor comprising magnetic materials with an in-plane magnetization direction according to a third embodiment of the present application.

FIG. 7 is a schematic diagram illustrating a cross-sectional view of a magnetic capacitor comprising magnetic materials with a perpendicular magnetization direction according to a fourth embodiment of the present application.

FIG. 8 is a schematic diagram illustrating a cross-sectional view of a magnetic capacitor with an isolative layer comprising a multilayer structure according to a fifth embodiment of the present application.

FIG. 9 is a schematic diagram illustrating a cross-sectional view of a magnetic capacitor with an isolative layer comprising a multilayer structure according to a sixth embodiment of the present application.

FIG. 10 is a schematic diagram illustrating a cross-sectional view of a magnetic capacitor with an isolative layer comprising a multilayer structure according to a seventh embodiment of the present application.

FIG. 11 is a schematic diagram illustrating a cross-sectional view of a magnetic capacitor with an isolative layer comprising a multilayer structure according to a eighth embodiment of the present application.

FIG. 12 is a schematic diagram illustrating a cross-sectional view of a magnetic capacitor comprising magnetic materials with an in-plane magnetization direction when the capacitor is charging according to a ninth embodiment of the present application.

FIG. 13 is a schematic diagram illustrating a cross-sectional view of a magnetic capacitor comprising magnetic materials with an in-plane magnetization direction when the capacitor is charging according to a tenth embodiment of the present application.

FIG. 14 is a schematic diagram illustrating a cross-sectional view of a magnetic capacitor comprising magnetic materials with an in-plane magnetization direction when the capacitor is charging according to an eleventh embodiment of the present application.

FIG. 15 is a schematic diagram illustrating a cross-sectional view of a magnetic capacitor comprising magnetic materials with an in-plane magnetization direction when the capacitor is charging according to a twelfth embodiment of the present application.

FIG. 16 is a schematic diagram illustrating a cross-sectional view of a magnetic capacitor comprising magnetic materials with an in-plane magnetization direction when the capacitor is charging according to a thirteenth embodiment of the present application.

FIG. 17 is a schematic diagram illustrating a cross-sectional view of a magnetic capacitor comprising magnetic materials with an in-plane magnetization direction when the capacitor is charging according to a fourteenth embodiment of the present application.

FIG. 18 is a schematic diagram illustrating a cross-sectional view of a magnetic capacitor comprising magnetic materials with an in-plane magnetization direction when the capacitor is charging according to a fifteenth embodiment of the present application.

### DETAILED DESCRIPTION

Reference will now be made in detail to the embodiments of the present application, examples of which are illustrated in the accompanying drawings. A numerical order of the embodiments is random. Wherever possible, the same reference numbers are used in the drawings and the description to refer to the same or like parts.

All figures are drawn for ease of explanation of the basic teachings of the present application only. The extensions of the figures with respect to number, position, relationship, and dimensions of the parts to form the embodiment will be explained or will be within the skill of the art after the following description has been read and understood.

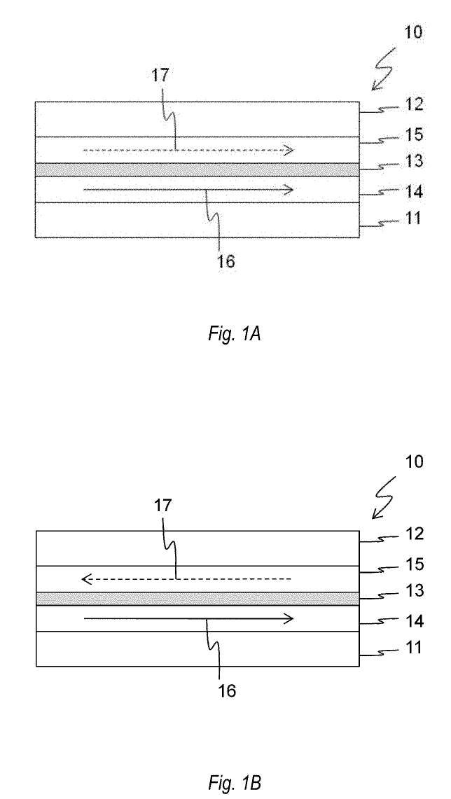

FIGS. 1A and 1B show a schematic diagram of a cross-sectional view of a magnetic capacitor 10 according to a first embodiment of the present application. The capacitor 10 can comprise a first conductive electrode 11, a second conductive electrode 12, a layer of an isolative material 13 disposed between the electrodes 11 and 12. The isolative layer 13 is separated from the electrodes 11 and 12 by magnetic layers 14 and 15, respectively. The magnetic layer 14 is disposed between the electrode 11 and the isolative layer 13 and has a direct contact with a side of the isolative layer 13. Similarly, the magnetic layer 15 is disposed between the isolative layer 13 and the electrode 12 and has a direct contact with an opposite side of the isolative layer 13.

The magnetic layers 14 and 15 can be made of magnetic material (or materials) comprising an in-plane anisotropy. One magnetic layer, for example the layer 14, can have a fixed magnetization direction 16 (shown by a solid arrow). The layer with the fixed magnetization direction is called a hard (or pinned) magnetic layer. The layer 15 can have a reversible magnetization direction 17 (shown by dashed arrow). The layer with the reversible magnetization direction is called a soft (or free) magnetic layer. The magnetization directions 16 and 17 in the adjacent magnetic layers 14 and 15, respectively, can be parallel (FIG. 1A) or anti-parallel (FIG. 1B) to each other. The parallel orientation of the magnetization directions 16 and 17 in the adjacent magnetic layers (FIG. 1A) corresponds to a low resistance state (a high leakage current) through the isolative layer 13. The anti-parallel orientation of the magnetization directions in the magnetic layers 14 and 15 (FIG. 1B) corresponds to a high resistance state (a low leakage current) between the layers. The magnetization direction 17 of the free magnetic layer 15 can be reversed from parallel to anti-parallel and vice-versa by an external magnetic field or by a spin-polarized current running between the magnetic layers through the isolative layer 13. Also a combination of the external magnetic field together with the spin-polarized current can be used for reversal of the magnetization direction in the magnetic layer 15. The magnetic layers 14 and 15 can have identical magnetic properties (can be both soft or both hard). In this case the orientation of the magnetization direction in the magnetic layers 14 and 15 (parallel or anti-parallel) can be controlled by a thickness of the isolative layer 13.

The first electrode 11 of the capacitor 10 can be made of a multilayer comprising a Ta(5 nm)/Ru(20 nm)/Ta(5 nm) structure. The pinned magnetic layer 14 can be made of 2-nm thick Co₇₀Fe₃₀ film having a substantial spin polarization. The isolative layer 13 can be made of a 1.5-nm thick film of TiO₂. The free magnetic layer 15 can be made of 3-nm thick film of Ni₈₁Fe₁₉. The second electrode 12 can be made of a three layer structure Ta(5 nm)/Ru(20 nm)/Ta(5 nm). The pinned layer 14 can have a structure of a synthetic anti-ferromagnetic comprising two ferromagnetic layers anti-ferromagnetically exchange coupled to each other through a non-magnetic spacer, for example CoFe/Ru/CoFe multilayer.

The parallel orientation of the magnetization directions 16 and 17 in the capacitor 10 is shown in FIG. 1A. It corresponds to a ferromagnetic exchange coupling between the magnetic layers 14 and 15. The ferromagnetic exchange coupling can have a low resistance state associated with a relatively high leakage current across the isolative layer 13. The capacitor 10 shown in FIG. 1B has anti-parallel orientation of the magnetization directions in the magnetic layers 14 and 15 which corresponds to the anti-ferromagnetic exchange coupling between the magnetic layers and a to high resistance state. The leakage current in the capacitor 10 with the anti-parallel exchange coupling can be several times lower than that of the ferromagnetic coupling between the magnetic layers 14 and 15. A type of exchange coupling (ferromagnetic or anti-ferromagnetic) and its strength depend on a thickness and properties of the isolative layer 13. Besides, the strength of the exchange coupling can depend on thickness and properties of magnetic layers 14 and 15, such as a saturation magnetization, anisotropy, crystalline texture and others.

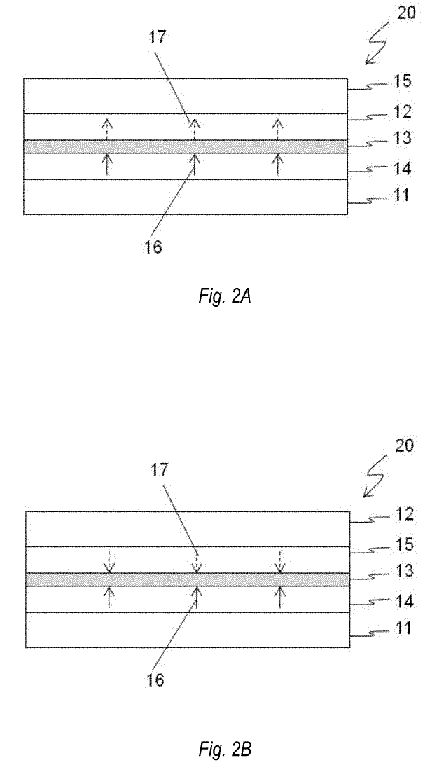

FIGS. 2A and 2B show a schematic diagram of a cross-sectional view of a magnetic capacitor 20 according to a second embodiment of the present application. The capacitor 20 distinguishes from the capacitor 10 shown in FIGS. 1A and 1B by use of the magnetic layers 14 and 15 with a perpendicular anisotropy. FIG. 2A shows the capacitor 20 with a ferromagnetic exchange coupling between the magnetic layers 14 and 15. Respectively, the capacitor 20 with the anti-ferromagnetic exchange coupling is shown in FIG. 2B. The capacitor 20 employing materials with perpendicular magnetization direction can have a smaller spin-polarized current required for reversal of the magnetization direction in the soft magnetic layer 15 compared to that in the capacitor with in-plane magnetization direction. The magnetic layers 14 and 15 can have identical magnetic properties (can be both soft or both hard). In this case the magnetization direction in the magnetic layers 14 and 15 (parallel or anti-parallel) can be controlled by a thickness of the isolative layer 13.

The first 11 and second 12 electrodes of the capacitor 20 can be made of Ta(5 nm)/Cu(20 nm)/Ta(5 nm) multilayers. A pinned magnetic layer 14 can be made of 2-nm thick film of Co₇₅Pt₂₅ alloy having a high coercivity (H_{C}≈3000 Oe) and a perpendicular anisotropy. The isolative layer 13 can be made of 1.3-nm thick film of Ta₂O₅. The soft magnetic layer 15 can be made of a 1.5-nm thick film of CoFeV having a perpendicular anisotropy. The pinned layer 14 can have a structure of a synthetic anti-ferromagnetic comprising two ferromagnetic layers anti-ferromagnetically exchange coupled to each other through a non-magnetic spacer, for example CoPt/Ru/CoFe multilayer.

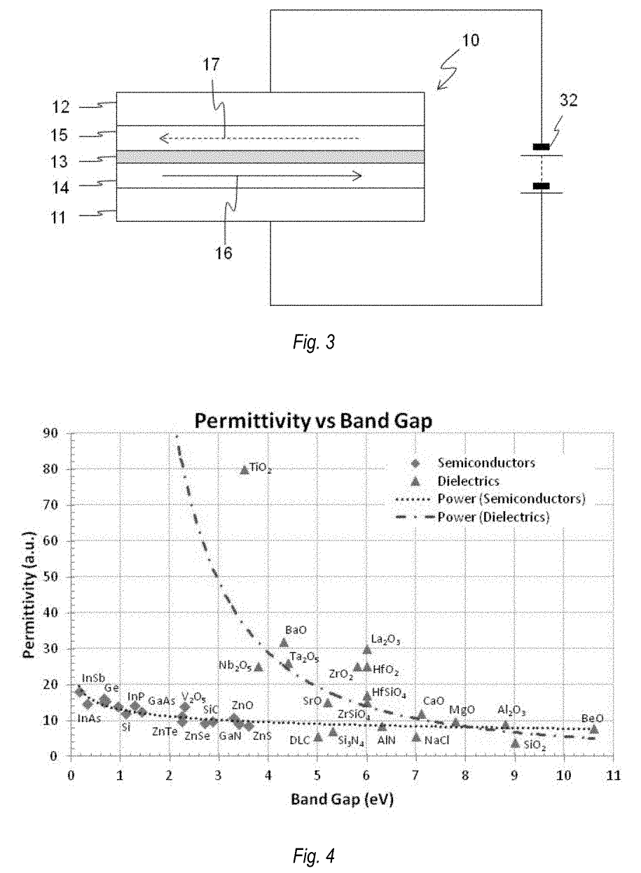

FIG. 3 shows a schematic diagram of the magnetic capacitor 10 electrically coupled to a battery 32 when the capacitor is charging. The capacitor 10 is electrically coupled to terminals of the battery 32 through the electrodes 11 and 12. The capacitor is in a high resistance state due to anti-ferromagnetic exchange coupling between ferromagnetic layers 14 and 15 through the isolative layer 13. The hard (or pinned) magnetic layer 14 can have a coercivity substantially higher than that of the soft (or free) magnetic layer 15. The anti-parallel configuration of the magnetization directions in the magnetic layers 14 and 15 can be arranged by coupling the soft magnetic layer 15 to a negative terminal of the battery 32 and the hard magnetic layer 14 to a positive terminal, respectively. An application of a spin-polarized current through the isolative layer 13 in a direction from the hard magnetic layer 14 towards the soft magnetic layer 15 through the isolative layer 13 can place the magnetization direction 17 anti-parallel to the magnetization direction 16. This mutual orientation of the magnetization directions corresponds to a low leakage current state between the electrodes 11 and 12. A density of the spin-polarized current required for reversal of the magnetization direction 17 can be in a range from 0.5·10⁶ A/cm² to 10·10⁶ A/cm². A voltage applied to the capacitor 10 should be less than a breakdown (dielectric) strength of the isolative layer 13. A theory suggests that the leakage current in the magnetic capacitor can be reduced by more than ten times by switching from the parallel to anti-parallel configuration of the magnetization directions in the magnetic layers 14 and 15.

A capacitance of the capacitor 10 can be calculated using an equation (1):

$$C = \frac{{ɛ}_{0} {ɛ}_{r} A}{d} \qquad ( 1 )$$

where C is the capacitance of the capacitor, ∈₀=8.854·10⁻¹² F/m is a dielectric constant of a free space (or a vacuum permittivity), ∈ᵣ is a relative dielectric constant (or a relative permittivity) of the isolative layer, A is an area of the parallel electrodes 11 and 12, and d is the distance between the electrodes. Equation (1) suggests that the capacitance C of the capacitor 10 is proportional to the area A of the parallel electrodes and to the relative permittivity ∈ᵣ of the isolative material, but inverse proportional to the distance d between the electrodes that is frequently equal to the thickness of the isolative layer.

A number of dielectric and semiconductor materials can be used for the isolative layer formation. Electrical properties of the dielectric and semiconductor materials depend on their band gap Eg. The band gap of the dielectric materials is about E_{g}≧5 eV. The semiconductors have band gap in a range of about 0.1 eV<E_{g}<5 eV. It should be noted, that there is not a well established border between dielectric and semiconductor materials based on their band gap value. For example, a diamond (a modification of carbon C) is considered as a wide band gap semiconductor with E_{g}=5.5 eV. The band gap E_{g} depends on impurities and defects. Hence, thin films of dielectric materials with the band gap E_{g}<6 eV or even higher (a bulk value) can perform as a semiconductor due to defects accumulated at their interfaces. These defects can cause a substantial reduction of the band gap of the dielectrics. The same is true for semiconductor materials. The effect of defects on electrical properties of dielectrics increases with film thickness reduction. This effect can be especially pronounced in laminates composed by materials having different values of E_{g}, for example in the laminates composed by dielectric and semiconductor layers of about 1-nm thick.

FIG. 3 shows a dependence of the relative permittivity on the band gap for several dielectric and semiconductor materials. There is a roughly inverse proportional dependence of the relative permittivity & on the band gap E_{g}. Lot of oxides belong to dielectric materials since they have a band gap above 5 eV at room temperature. However, there is a number of oxides having the band gap smaller than 5 eV. These oxide can be considered as semiconductors, for example VₓO_{y}, ZnₓO_{y}, CuₓO_{y}, MoₓO_{y}, and similar.

The relative permittivity of perovskite oxides exhibiting a ferroelectric effect can exceed a thousand (∈ᵣ>1000). The perovskites include BaTiO₃, CaTiO₃, SrTiO₃, LiBbO₃, LiTaO₃, CaCuTiO₃, BaZrTiO₃, BaCaTiZrO₃, WO₃, and similar oxides. The permittivity of the perovskites is very sensitive to their crystalline structure: it is high (∈ᵣ>100) for polycrystalline and single crystal structure, especially, and relatively low (∈ᵣ<100) for amorphous perovskite films.

A stored energy W is another important parameter of the capacitor. The capacitor energy is defined by an equation (2)

$$W = \frac{{CV}^{ 2}}{2} = {ɛ}_{0} {ɛ}_{r} {E}^{2} \frac{Ad}{2} \qquad ( 2 )$$

where V is a voltage applied to the capacitor, a product of the isolative layer thickness d and the capacitor area A represents a volume of the isolative material, E is a electric field across the isolative layer. The maximum energy of the capacitor is defined by a breakdown (dielectric) strength E_{bd} of the isolative material.

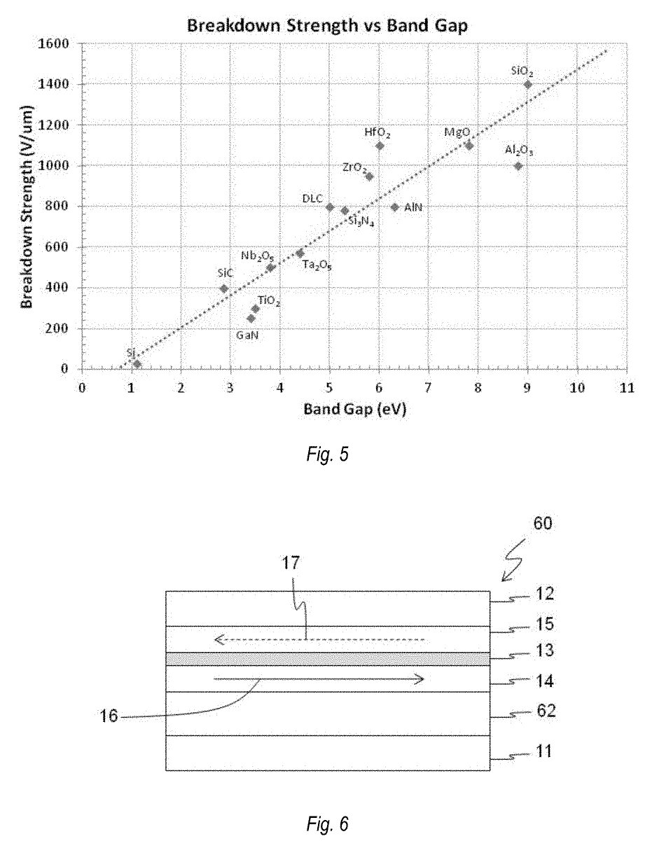

FIG. 5 shows a dependence of the breakdown strength E_{bd} on the band gap E_{g} for several dielectric and semiconductor materials that can be used in thin-film capacitors. The breakdown strength E_{bd} has almost linear dependence on the band gap E_{g}. According to the equation (2), an increase of the capacitor energy can be achieved either raising the dielectric permittivity ∈ᵣ or the breakdown voltage E_{bd}. The increase of the breakdown strength looks more attractive because of its square relationship with the energy.

In a magnetic capacitor the permittivity of the isolative layer 13 can be increased by more than thousand times resulting in a significant capacitance increase. At an interface formed by the isolative and magnetic layers a symmetry of physicals properties of the contacting materials is broken. A violation of the symmetry can cause a strong hybridization between sp and d bands of the ferromagnetic and isolative layers at their interface. The hybridization may cause a spin polarization of free electrons (created by defects or impurities) in the isolative layer resulting in a significant increase of an electric polarization of the isolative layer. The electric polarization of the isolative layer deposed between two ferromagnetic layers can be significantly magnified when the magnetic layers are exchange coupled to each other. Strength of the exchange can be controlled by a thickness and conductivity of the isolative layer, and by properties of the magnetic layers. Hence, the permittivity of the isolative layer 13 can be controlled by a strength of exchange coupling between the magnetic layers. A nature of this phenomenon is not fully understood at the moment. The isolative layer can be made of dialectic or semiconductor materials, or their based laminates.

FIG. 6 shows a schematic diagram of a cross-section view of a magnetic capacitor 60 according to a third embodiment of the present application. A pinning anti-ferromagnetic layer 62 is provided to the capacitor 60 to pin the magnetization direction 16 in the pinned magnetic layer 14. Due to exchange coupling between the magnetic layers 14 and 15, the magnetization direction 17 in the free magnetic layer 15 can be parallel or anti-parallel to the magnetization direction 16 in the pinned magnetic layer 14. Both magnetic layers 14 and 15 can have an in-plane anisotropy. The anti-ferromagnetic layer 62 is disposed between a first conductive electrode 11 and a pinned magnetic layer 14. The pinning anti-ferromagnetic layer 62 has a substantial exchange coupling with the pinned magnetic layer 14 to pin (or to fix) its magnetization direction 16 (solid arrow). The pinning anti-ferromagnetic layer 62 can prevent the pinned magnetic layer 14 from a reversal of its magnetization direction 16 when an external magnetic field or a spin-polarized current is applied to the capacitor 60.

A first electrode 11 of the capacitor 60 can be made of a multilayer structure comprising 5-nm thick film of Ni₈₁Fe₁₉ deposited on a top of Ta(10 nm)/Ru(30 nm)/Ta(10 nm) structure. The anti-ferromagnetic layer 62 can be made of 15-nm thick film of Ir₅₀Mn₅₀ alloy. The pinned magnetic layer 14 can be made of 2.5-nm thick Co₇₀Fe₃₀ film having a substantial spin polarization. The isolative layer 13 can be made of 1.5-nm thick film of n-type SiC with a doping concentration of phosphorus (P) of about 10¹³ cm⁻³. A free magnetic layer 15 can be made of a bilayer structure composed by 1.5-nm thick film of Co₇₀Fe₃₀ and 2-nm thick film of Ni₈₁Fe₁₉ with the Co₇₀Fe₃₀ film having a direct contact with the isolative layer 13. The second electrode 12 can be made of a three layer structure Ta(10 nm)/Ru(30 nm)/Ta(10 nm).

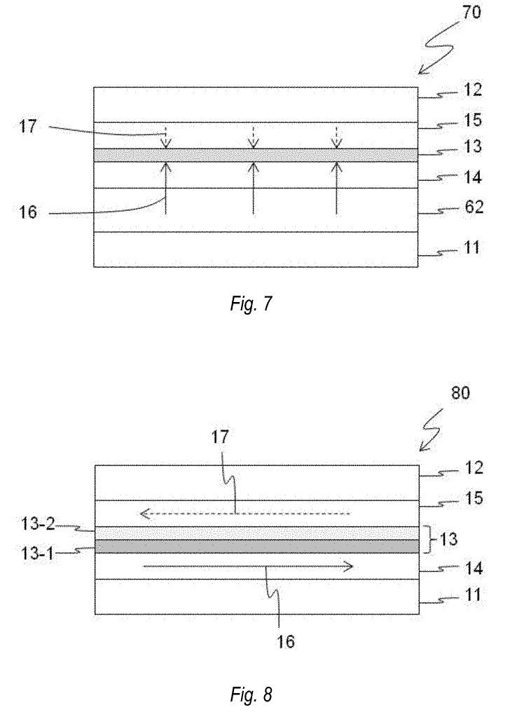

FIG. 7 shows a schematic diagram of a cross-sectional view of a magnetic capacitor 70 according to a fourth embodiment of the present application. The capacitor 70 employs magnetic layers having a perpendicular anisotropy. A pinning layer 62 is disposed between a pinned magnetic layer 14 and the first electrode 11. The pinning layer 62 has a substantial exchange coupling with the pinned magnetic layer 14. The exchange coupled layers 14 and 62 work as a single hard magnetic layer. The pinning magnetic layer can be made of a hard magnetic material having a coercivity of about H_{C}>500 Oe. Besides, the pinning layer 62 can be made of rear earth-transition metals (RE-TM) alloys.

A first electrode 11 of the capacitor 70 can be made of Ta(10 nm)/Cu(25 nm)/Ni₃₈Cr₆₂(7 nm) multylayer structure. The pinning magnetic layer 62 can be made of Co₇₄Pt₁₆Cr₁₀ alloy having a thickness of 15 nm and a coercive force of about 3.5 kOe or above. The pinned layer 14 can be made of 2.5-nm thick film of Co₅₀Fe₅₀. The layers 62 and 14 can be substantially exchange coupled to each other and can work as a single magnetic layer with a perpendicular magnetization direction 16. The isolative layer 13 can be made of 1.5-nm thick layer of SrTiO₃ oxide. A free magnetic layer 15 can be made of 1.2-nm thick film of Fe₆₀Co₂₀B₂₀ having a perpendicular magnetization direction 17. A second electrode 12 can be made of a multilayer structure Hf(5 nm)/Ta(5 nm)/Cu(25 nm)/Ta(10 nm) where Hf film has a direct contact with the free magnetic layer 15.

According to equation (2) the energy stored in the capacitor depends both on the permittivity ∈ᵣ and breakdown strength E_{bd} of the isolative material. Normally materials exhibiting high permittivity ∈ᵣ have a relative low breakdown strength E_{bd} and vise versa. To increase the energy stored in capacitor laminates (multilayers) of the different isolative materials having high values of permittivity ∈ᵣ and breakdown strength E_{bd} but different values of band gap E_{g} can be used. Surface charges accumulate at the interface of two materials having different band gaps (different electric conductivities). These charges can increase substantially an energy stored in the capacitor. For example, multilayers Al₂O₃/TiO₂, SiO₂/Si-poly, SiO₂/SiC, SiO₂/ZnO, MgO/TiO₂, ZrO₂/TiO₂, BeO/TiO₂, Al₂O₃NO₂, Al₂O₃/WO₃, BaTiO₃/MgO, BaZrO₃/ZrO₂, HfO₂/BaO, WO₃/BeO, and others can provide the magnetic capacitor with a high energy density.

Moreover, the isolative layer comprising the above laminates and disposed between two magnetic layers substantially exchange coupled to each other can exhibit a giant value of the permittivity ∈ᵣ>1·10⁷. The giant permittivity can result from a spin polarization of free electrons at the interfaces formed by the isolative and magnetic layers and inside of the laminated isolative layer.

FIG. 8 shows a schematic diagram of a cross-sectional view of a magnetic capacitor 80 according to a fifth embodiment of the present application. The capacitor 80 distinguishes from the capacitor 10 shown in FIGS. 1A and 1B by use of the isolative layer 13 having a multilayer structure (laminates). The isolative layer can include two sublayers 13-1 and 13-2 having different values of the band gap E_{g}. For example, the sublayer 13-1 can be made of 0.6-nm thick film of Al₂O₃ having a high breakdown strength E_{bd}≈1000 V/μm (E_{g}=8.8 eV), and the sublayer 13-2 can be made of 0.7-nm thick film of TiO₂ having a high permittivity ∈ᵣ=80 (E_{g}=3.5 eV). The magnetic layers 14 and 15 can be made of cobalt (Co) having a thickness of about 2 nm and 3 nm, respectively. The electrodes 11 and 12 can be made of TiN(10 nm)/Al(30 nm)/Cr(10 nm) and TiN(10 nm)/Al(30 nm)/TiN(10 nm) multilayers, respectively. Number of Al₂O₃/TiO₂ bilayers in the isolative layer 13 can be any.

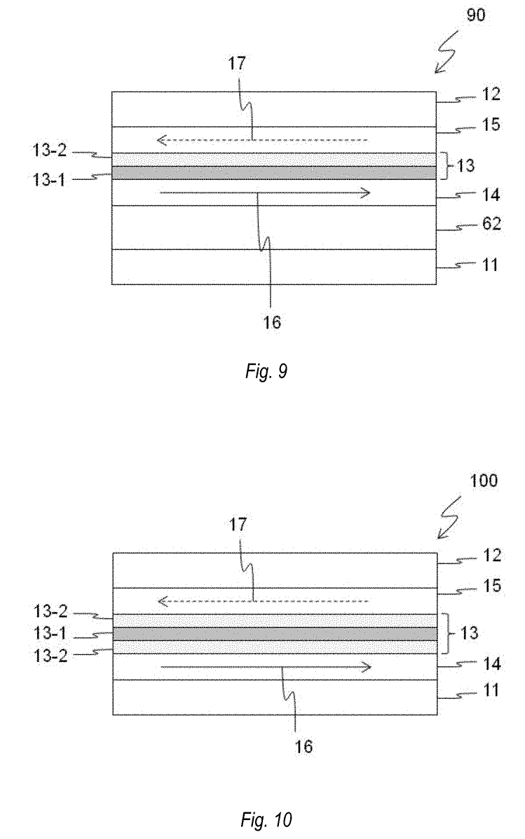

FIG. 9 shows a schematic diagram of a cross-sectional view of a magnetic capacitor 90 according to a sixth embodiment of the present application. The capacitor 90 distinguishes from the magnetic capacitor 60 shown in FIG. 6 by use of laminated isolative layer 13. The layer 13 can have a bilayer structure composed by sublayers 13-1 and 13-2. The sublayer 13-1 can be made of 0.5-nm thick layer of SiO₂ having a high breakdown strength E_{bd}≈1400 V/μm (E_{g}=9 eV). The sublayer 13-2 can be made of 1-nm thick film of polycrystalline Si (poly-Si) having a permittivity ∈ᵣ>12 (E_{g}=1.1 eV). The magnetic layers 14 and 15 can be made of Ni₈₁Fe₁₉ alloy and can have a thickness of 2 nm and 3 nm, respectively. The pinning layer 62 can be made of 15-nm PtMn-alloy. Number of bilayer repeats in the isolative layer 13 can be any.

FIG. 10 shows a schematic diagram of a cross-sectional view of a magnetic capacitor 100 according to a seventh embodiment of the present application. The capacitor 100 comprise an isolative layer 13 made of three sublayers. The sublayer 13-1 can be made of about 0.6-nm thick MgO film having a high breakdown strength E_{bd}=1200 V/μm (E_{g}=7.8 eV) and disposed between two sublayers 13-2 made of 0.6-nm thick films of Ta₂O₅ having a relatively high permittivity ∈ᵣ>26 (E_{g}=4.4 eV).

FIG. 11 shows a schematic diagram of a cross-sectional view of a magnetic capacitor 110 according to an eighth embodiment of the present application. The capacitor 110 distinguishes from the capacitor 100 (FIG. 10) by use of two sublayers 13-1 made of. The sublayers 13-2 can be made of 0.5-nm thick films of Al₂O₃ having a high breakdown strength E_{bd}≈1000 V/μm (E_{g}=9 eV), and one sublayer 13-2 made of 0.7-nm thick TiO₂ film having a high permittivity ∈ᵣ≈80 (E_{g}=3.5 eV). The sublayer 13-2 is disposed between two sublayers 13-1. The magnetic layer 14 can be made of 2-nm thick Co₇₅Pt₂Cr₁₃ alloy. The magnetic layer 15 can be made of 3-nm thick Co. Electrodes 11 and 12 can be made of Ta(10 nm)/CuN(25 nm)/Ta(10 nm).

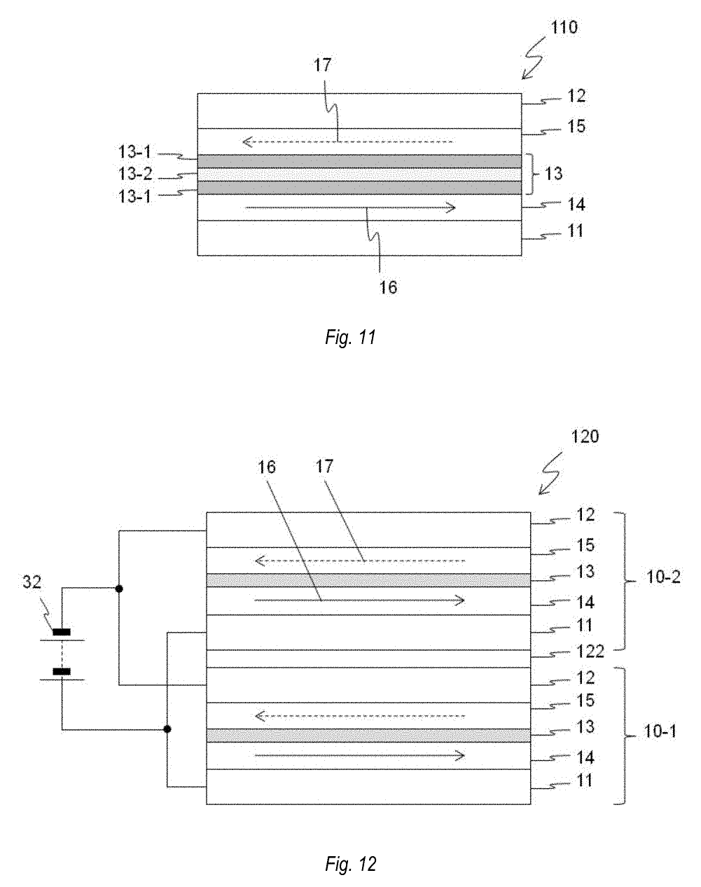

FIG. 12 shows a schematic diagram of a cross-sectional view of a magnetic capacitor 120 according to a ninth embodiment of the present application. The capacitor 120 comprises two sections 10-1 and 10-2 electrically coupled to a battery 32. The sections 10-1 and 10-2 stacked above each other and have a similar structure. The sections 10-1 and 10-2 have a structure of the capacitor 10 shown in FIG. 1. The sections 10-1 and 10-2 are electrically isolated from each other by a spacer layer 122. The spacer layer 122 can be made of a dielectric material or laminates. For example, the spacer layer 122 can be made of 20-nm thick film of SiO₂. The sections 10-1 and 10-2 are electrically coupled to each other in parallel. For example, the pinned magnetic layers 14 of the sections 10-1 and 10-2 are coupled to each other. The magnetization directions 16 in the magnetic layers 14 are parallel to each other. Respectively, the free magnetic layers 15 of the sections 10-1 and 10-2 are electrically coupled to each other. The magnetization directions 17 in the magnetic layers 15 are parallel to each other. Then, the first electrodes 11 of the sections 10-1 and 10-2 are electrically coupled to a first terminal of the battery 32. Respectively, the second electrodes 12 of the sections 10-1 and 10-2 are electrically coupled to a second terminal of the battery 32. The number of sections in the capacitor 120 can be any.

Each of the sections 10-1 and 10-2 in parallel coupled to each other is exposed to the same voltage. Their capacitances add up. An electric charge is distributed among the sections according to their capacitances. Accordingly, the total capacitance of the two sections 10-1 and 10-2 represents a sum of their capacitances:

C_{TOTAL}=C₁₀₋₁+C₁₀₋₂ (3)

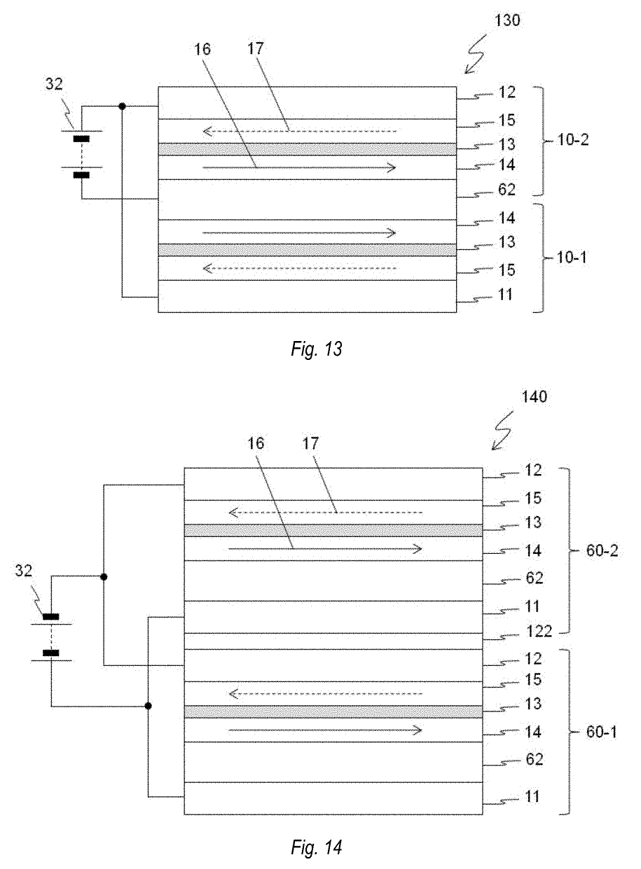

FIG. 13 shows a schematic diagram of a cross-sectional view of a magnetic capacitor 130 when the capacitor is charging according to a tenth embodiment of the present application. The capacitor 130 comprises one pinning anti-ferromagnetic layer 62 substantially exchange coupled to two pinned magnetic layers 14 disposed on opposite sides of the layer 62. Each of the magnetic layers 14 has a fixed magnetization direction 16. The anti-ferromagnetic layer 62 can be made of a 15-nm thick film of Ir₅₀Mn₅₀ alloy. The pinned magnetic layers 14 of the section 10-1 and 10-2 by means of the conductive anti-ferromagnetic layer 62 can be electrically coupled to a first terminal of a battery 32. Free magnetic layers 15 of the sections 10-1 and 10-2 by means of the first 11 and second 12 conductive electrodes of the capacitor 130 can be coupled in parallel to a second terminal of the battery 32. A number of the sections in the capacitor 130 can be any.

FIG. 14 shows a schematic diagram of a cross-sectional view of a magnetic capacitor 140 when the capacitor is charging according to an eleventh embodiment of the present application. The capacitor 140 distinguishes from the capacitor 130 (FIG. 13) by use of two pinning anti-ferromagnetic layers 62, a first layer is disposed in the section 60-1 and a second layer is disposed in the section 60-2. Design of the section 60-1 and 60-2 is disclosed above (see FIG. 6). The sections 60-1 and 60-2 are electrically isolated from each other in the stack by a spacer layer 122 that can be made of a dielectric layer or multilayer. For example, the spacer layer 122 can be made of about 20-nm thick film of Al₂O₃. The sections 60-1 and 60-2 are in parallel coupled to each other and to appropriate terminals of the battery 32. For example, the first electrodes 11 of the sections 60-1 and 60-2 are electrically coupled to a first terminal of the battery 32. Respectively, the second electrodes 12 of the sections 60-1 and 60-2 are electrically coupled to the second terminal of the battery 32. A number of the sections in the capacitor 140 can be any.

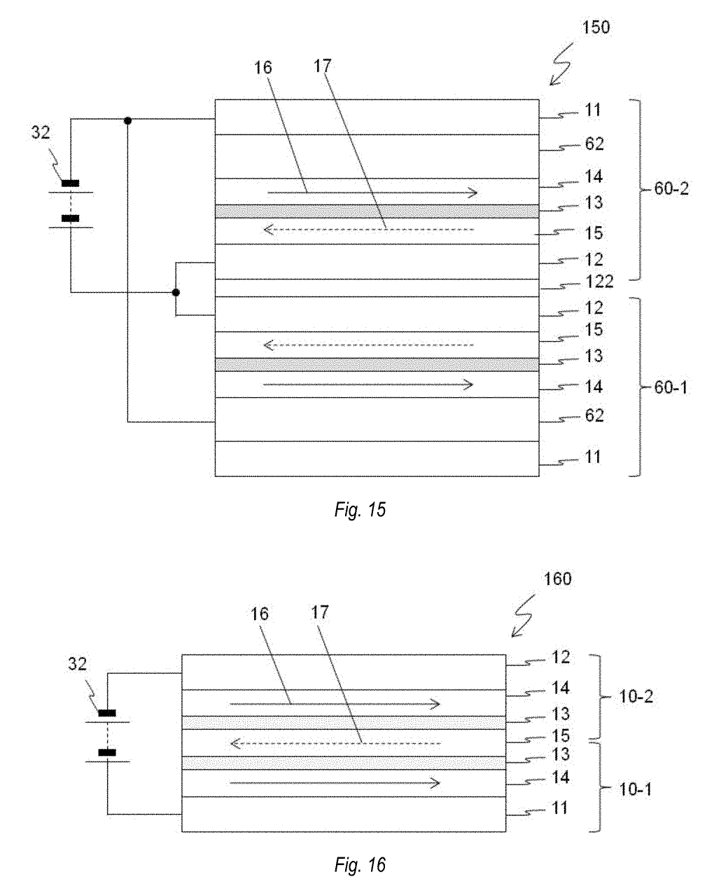

FIG. 15 shows a schematic diagram of a cross-sectional view of a capacitor 150 when the capacitor is charging according to of a twelfth embodiment to the present application. Sections 60-1 and 60-2 of the capacitor 150 are connected to each other in parallel. The sections 60-1 and 60-2 are electrically isolated from each other by a spacer layer 122 made of 30-nm thick film of Si₃N₄. The section 60-2 has a reversed order of layers in a stack respectively to that of the section 60-1. The pinned magnetic layers 14 of the sections 60-1 and 60-2 are electrically coupled in parallel to the second terminal of a battery 32. Respectively, the free magnetic layers 15 of the sections 60-1 and 60-2 are electrically coupled in parallel to the first terminal of the battery 32. A number of the sections in the capacitor 150 can be any.

FIG. 16 shows a schematic diagram of a cross-sectional view of a capacitor 160 when the capacitor is charging according to of a thirteenth embodiment to the present application. The capacitor 160 comprises two sections 10-1 and 10-2 stacked one above the other. The sections 10-1 and 10-2 are disclosed above (FIGS. 1A and 1B). The sections 10-1 and 10-2 are coupled to each other in series by means of the common free layer 15. Bottom 11 and top 12 electrodes of the capacitor 160 are coupled to the terminals of the battery 32. The isolative layers 13 can have a multilayer structure. Note, that the capacitor 160 can have a common pinned layer 14 with two free layers 15 disposed adjacent to the opposite sides of the pinned layer 16.

Each section of the capacitor 160 shown in FIG. 16 can store an equal electrical charge. The total capacitance C_{TOTAL} of the sections 10-1 (C₁₀₋₁) and 10-2 (C₁₀₋₂) connected in series is smaller than that of any of its components:

$$\frac{1}{{C}_{TOTAL}} = \frac{1}{{C}_{10 - 1}} + \frac{1}{{C}_{10 - 2}} \qquad ( 3 )$$

However, the capacitor 160 comprising several sections connected in series can operate under higher voltage. A number of sections in the stack of the capacitor 160 can be any.

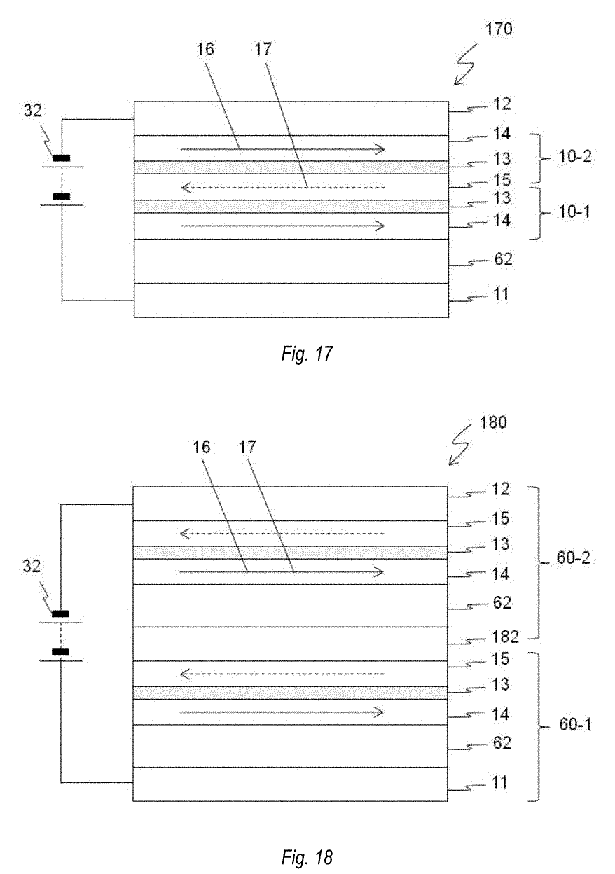

FIG. 17 shows a schematic diagram of a cross-sectional view of a capacitor 170 when the capacitor is charging according to a fourteenth embodiment of the present application. The capacitor 170 distinguishes from the capacitor 160 shown in FIG. 16 by use of a pinning layer 62 in the section 10-1. The pinning layer can be made of 20-nm thick film of Pt₅₀Mn₅₀ anti-ferromagnetic alloy. The isolative layers 13 can have a multilayer structure. A number of the section in the capacitor 170 can be any. A second pinning layer 62 can be disposed in the section 10-2 adjacent to a top surface of the pinned layer 14 of the section 10-2.

FIG. 18 shows a schematic diagram of a cross-sectional view of a capacitor 180 when the capacitor is charging according to a seventh embodiment of the present application. Sections 60-1 and 60-2 of the capacitor 180 are connected in series to each other by means of a conductive spacer layer 182. The free magnetic layer 15 of the section 60-1 is electrically coupled to a pinned magnetic layer 14 of the section 60-2 through the pinning layer 62 made of conductive anti-ferromagnetic Mn-based alloy and through the conductive spacer layer 182. Each of the sections 60-1 and 60-2 comprises a pinning anti-ferromagnetic layer 62 exchange coupled to a pinned magnetic layer 14, a free magnetic layer 15, and an isolative layer 13 disposed between the pinned and free magnetic layers 14 and 15, respectively. The isolative layers 13 can have a multilayer structure. A number of sections in the stack can be any.

A first electrode 11 and the conductive spacer layer 182 of the capacitor 180 can be made of Ta(10 nm)/Cu(20 nm)Ta(10 nm)/NiFe(5 nm) multilayer with NiFe layer disposed adjacent to the anti-ferromagnetic layer 62. The pinning anti-ferromagnetic layers 62 can be made of a 15-nm thick films of Ir₅₀Mn₅₀ alloy. The pinned magnetic layers 14 can be made of 3-nm thick films of CoFeB having a high spin polarization. ZrO₂(0.5 nm)/BaTiO₃(1 nm)/ZrO₂(0.5 nm) multilayers can be used as the isolative layers 13. A second electrode 12 can be made of Ta(10 nm)/Cu(25 nm)/Ta(10 nm) multilayer. The conductive spacer layer 182 can be made of 10-nm thick Ta.

The capacitor 80-180 shown in FIGS. 8-18, respectively, can have magnetic layers 14 and 15 comprising a perpendicular anisotropy. The pinning layer 62 can be made of anti-ferromagnetic, ferrimagnetic and/or hard ferromagnetic magnetic materials substantially exchange coupled with the pinned layer 14.

There is a wide latitude for the choice of materials and their thicknesses within the embodiments of the present application.

Conductive electrodes 11 and 12 can be made of a conductive material such as Ta, Ru, Ti, Pt, Pd, Au, Cu, Al, W, TiN, TaN and similar, their based alloys and/or laminates. Thickness of the conductive electrodes 11 and 12 can be in a range from about 1 nm to about 1 μm.

An isolative layer 13 can be made of alkaline earth metal oxides, such as BeO, MgO, BaO, and others; transition metal oxides, such as TiO₂, Ta₂O₅, Nb₂O₅, ZnO, NiO, and others; lanthanide oxides, such as La₂O₃, Gd₂O₃, Tb₂O₃, and others; post-transition metal oxides, such as Al₂O₃, Ga₂O₃, In₂O₃, and others; metalloid oxides, such as B₂O₃, SiO₂, GeO₂, and others; perovskite-type materials, such as BaTiO₃, CaTiO₃, SrTiO₃, LaAlO₃, LiTaO₃, CaCuTiO₃, BaZrTiO₃, BaCaTiZrO₃, and similar, and/or their based laminates. The isolative layer 13 can be made of semiconductor materials such as Si, Ge, C, Se, Te, SiC, BN, AlN, GaN, GaP, GaAs, GaP, InP, CdS, CdSe, CdTe, poly-Si and similar, and/or their based laminates with a doping concentration not more than 10¹³ cm⁻³. The isolative layer 13 can be made of Si₃N₄, AlN, GaN and other nitrides. A thickness of the isolative layer 13 can be in a range from about 0.2 nm to about 50 nm. A thickness of the sublayers 13-1 and 13-2 can be in a range from about 0.2 nm to about 5 nm.

Magnetic layers 14 and 15 can be made of magnetic material comprising at least one element selected from a group consisting of Fe, Co, Ni, their based alloys and laminates. For example, the magnetic layer 14 and 15 can be made of Co, Fe, CoFe, CoFeB, CoFeVB, NiFe, NiFeCo and similar; laminates (Co/Pt)n, (Co/Pd)n, (CoFe/Pt)n and similar; disordered alloys CoPt, CoCr, CoPtCr, CoCrTa, CoCrNb and similar; ordered alloys such as Fe₅₀Pt₅₀, Fe₅₀Pd₅₀, Co₅₀Pt₅₀, Fe₃₀Ni₂₀Pt₅₀, Co₃₀Fe₂₀Pt₅₀, Co₃₀Ni₂₀Pt₅₀ and similar; artificial lattices such as Co/Ru, Co/Os, Ni/Co, Co/W, Co/Ta and similar. A thickness of the magnetic layers 14 and 15 can be in a range from of about 1 nm to about 100 nm.

A pinning layer 62 can be made of an anti-ferromagnetic alloy, such as FeMn, NiMn, PtMn, PtPdMn, IrMn, CrPtMn, RuMn, OsMn and/or their based laminates. The pinning layer 62 can be made of a ferrimagnetic material such as GdTb, GdTbCo, TbFe, GdFe, TbFeCo, GdFeCoBi, TbDyCo, GdHoCo, and similar. The pinning layer 62 can be made of ferromagnetic material having a coercive force H_{C}>500 Oe, such as CoCr, CoNiCr, CoPt, CoPtCr, SmCo, FePt, and similar. Thickness of the pinning layer 62 can be in a range from 1 nm to 100 nm.

A spacer layer 122 can be made of a dielectric material, such SiO₂, Al₂O₃, Si₃N₄, Ta₂O₅ and similar, or semiconductor materials such as C, SiC, BN, AlN, AlP, GaN, and similar, and/or their based laminates. Thickness of the spacer layer 122 can be in a range from about 1 nm to about 1 μm.

A conductive spacer layer 182 can be made of conductive materials such as Ta, Ru, Ti, Pt, Pd, Au, Cu, Ni, W, TiN, and similar, their based alloys and/or laminates. Thickness of the layer 182 can be in a range from about 1 nm to about 1 μm.

While the specification of this disclosure contains many specifics, these should not be construed as limitations on the scope of the disclosure or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It is understood that the above embodiments are intended to be illustrative, and not restrictive. Many other embodiments will be apparent to those of skill in the art upon reviewing the above description. The scope of the embodiments should be, therefore, determined with reference to the appended claims, along with the full scope of equivalents to which such claims are entitled.

While the disclosure has been described in terms of several exemplary embodiments, those skilled in the art will recognize that the disclosure can be practiced with modification within the spirit and scope of the appended claims. Specifically, one of ordinary skill in the art will understand that the drawings herein are meant to be illustrative, and the spirit and scope of the disclosure are not limited to the embodiments and aspects disclosed herein but may be modified.

What is claimed is:

1. An apparatus for storing an electrical energy comprising:
a first conductive electrode,
a second conductive electrode,
an isolative layer disposed between the first and second conductive electrodes,
a first magnetic layer disposed between the isolative layer and the first conductive electrode, and
a second magnetic layer disposed between the isolative layer and the second conductive electrode,
wherein the isolative layer comprising at least:
a first sublayer having a band gap equal or more than 5 eV, and
a second sublayer having the band gap less than 5 eV.

2. The apparatus of claim 1 wherein the first sublayer comprising BeO, MgO, CaO, SrO, La₂O₃, Gd₂O₃, Lu₂O₃, HfO₃, ZrO₂, HfO₂, Sc₂O₃, Y₂O₃, Al₂O₃, Ga₂O₃, B₂O₃, SiO₂, GeO₂, HfSiO₄, ZrSiO₄, AlN, Si₃N₄, diamond-like carbon, their based compounds and/or laminates.

3. The apparatus of claim 1 wherein the second sublayer comprising an oxide of Ta, Nb, Ba, Ti, W, Mo, V, Zn, Cr, Mn, Fe, Co, Ni, Cu, Zn, Cd, Tl, Pb, Bi, In, Sn, or Tb.

4. The apparatus of claim 1 wherein the second sublayer comprising a perovskite-type oxide.

5. The apparatus of claim 1 wherein the second sublayer comprising a semiconductor material having a doping concentration less than 10¹³ cm⁻³.

6. The apparatus of claim 1 wherein the first sublayer having a thickness in a range from 0.2 nm through 3 nm.

7. The apparatus of claim 1 wherein the second sublayer having a thickness in a range from 0.2 nm through 5 nm.

8. The apparatus of claim 1 wherein the first and second magnetic layers comprising a magnetic material having an in-plane anisotropy.

9. The apparatus of claim 1 wherein the first and second magnetic layers comprising a magnetic material having a perpendicular anisotropy.

10. The apparatus of claim 1 wherein at least one of the first and second magnetic layers comprising a multilayer structure.

11. The apparatus of claim 1, further comprising a pinning layer having a direct contact with the first magnetic layer.

12. The apparatus of claim 11 wherein the pinning layer comprising an anti-ferromagnetic material or ferrimagnetic material.

13. The apparatus of claim 11 wherein the pinning layer comprising a ferromagnetic magnetic having a coercive force above 500 Oe.

14. The apparatus of claim 1 wherein the first magnetic layer comprising a synthetic anti-ferromagnetic having a laminated structure.

15. An apparatus for storing an electrical energy comprising:
a first conductive electrode,
a second conductive electrode,
an isolative layer disposed between the first and second conductive electrodes and comprising a multilayer structure,
a first magnetic layer disposed between the isolative layer and the first conductive electrode, and
a second magnetic layer disposed between the isolative layer and the second conductive electrode,
wherein the isolative layer comprising:
a first sublayer disposed adjacent to the first magnetic layer and comprising a material having a band gap equal or more than 5 eV;
a second sublayer comprising a material having the band gap less than 5 eV, and
a third sublayer disposed adjacent to the second magnetic layer and comprising a material having the band gap equal or more than 5 eV.

16. The apparatus of claim 15 wherein the first and third sublayers having a thickness in a range from 0.2 nm through 3 nm.

17. The apparatus of claim 15 wherein the second sublayer having a thickness in a range from 0.2 nm through 5 nm.

18. An apparatus for storing an electrical energy comprising:
a first conductive electrode,
a second conductive electrode,
an isolative layer disposed between the first and second conductive electrodes and comprising a multilayer structure,
a first magnetic layer disposed between the isolative layer and the first conductive electrode and having a direct contact with a first side of the isolative layer, and
a second magnetic layer disposed between the isolative layer and the second conductive electrode and having a direct contact with a second side of the isolative layer opposite to the first side,
wherein the isolative layer comprising:
a first sublayer disposed adjacent to the first magnetic layer and comprising a material having a band gap less than 5 eV;
a second sublayer comprising a material having the band equal or more than 5 eV, and
a third sublayer disposed adjacent to the second magnetic layer and comprising a material having the band gap less than 5 eV.

19. The apparatus of claim 18 wherein the first and third sublayers having a thickness in a range from 0.2 nm through 5 nm.

20. The apparatus of claim 18 wherein the second sublayer having a thickness in a range from 0.2 nm through 3 nm.
